(19) United States
(12) Patent Application Publication
(10) Pub. No.: US 2006/0285940 A1
(43) Pub. Date: Dec. 21, 2006

(54) Screw For Use In Concrete

(75) Inventor: Uli Walther, Thunder Bay (CA)

Correspondence Address: BUCHANAN, INGERSOLL & ROONEY PC, POST OFFICE BOX 1404, ALEXANDRIA, VA, 22313-1404, US

(73) Assignees: Mirco Walther, Thunder Bay (CA); Uli Walther, Thunder Bay (CA); Gerda Walther, Thunder Bay (CA)

(21) Appl. No.: 11/161,425

(22) Filed: Aug. 2, 2005

(30) Foreign Application Priority Data
Jun. 16, 2005 (CA) 2,510,200

(51) Int. Cl. F16B 35/04

(52) U.S. Cl. 411/421

(57) ABSTRACT

A screw fastener for use in a masonry element having a pilot hole of predetermined length and diameter, the screw fastener including a shank having a diameter less than the diameter of the pilot hole, and having a tip at one end and a head at the other end; a set of helical threads extending from the tip over a portion of the length of the shank, wherein the threads have a pitch at least as great as the diameter of the shank; and a set of one or more helical grooves of the opposite rotational hand to the threads, which grooves extend through the threads and into the shank, wherein the pitch of the grooves is in the range of two to twenty times the diameter of the shank.

### FIELD OF THE INVENTION

The present invention relates generally to a screw fastener, which is adapted to be secured in a hole drilled in a masonry structure such as concrete but it may be used in other masonry materials such as brick or ceramic. The screw is of a type, sometimes called Hi-Lo, having a major thread of a major crest diameter, and an intermediate minor thread of minor crest diameter.

### BACKGROUND OF THE INVENTION

Concrete screws, namely screws adapted for use in a concrete or other masonry substrate, typically are screwed, either by hand or power tools, into an appropriately sized bore hole in which the diameter of the bore hole is slightly greater than the diameter of the shank of the screw, while the crest diameter of the threads of the screw exceed the diameter of the bore hole.

Typically, the threads of concrete screws cut into the sidewalls of the borehole. Heretofore, screws with a fine pitch have been utilized, allowing multiple convolutions of threads in contact with the wall of the borehole, typically with a thread height which provided shallow penetration of the threads into the walls of the boreholes. With many shallow threads in close proximity, pullout of concrete screws is a problem. With increased diameter of threads while maintaining the same pitch and same shank and borehole diameters, greater pullout resistance can be obtained. However, such a screw structure increases the risk of over-cutting the sidewalls and even “drilling out” the concrete on an over-torqued screw. In any event, the result of increasing the number of thread convolutions and consequent length of thread contacting the sidewalls, resistance to rotation increases. Unfortunately, many concrete screws suffer from this increased resistance, whereby the torque required to sink the screw to the desired depth results in over-torquing of the screw and shearing of the screw shank.

In order to reduce the shear resistance, screws having two different shank diameters have been disclosed, as in U.S. Pat. No. 5,061,136. Other screws have employed a thread of gradually increasing diameter as in U.S. Pat. No. 4,842,467. A Hi-Lo screw with a line of symmetrical thread notches is disclosed in U.S. Pat. No. 3,937,119.

U.S. Pat. No. 877,131 discloses a wood screw with drill & countersinking flutes extending into the head of the screw. U.S. Pat. No. 1,235,626 discloses a wood screw with a drill flute therein. U.S. Pat. No. 4,697,969 also discloses a wood screw with one or more spiral drill flutes, of the same rotational hand as the thread.

The present screw provides a Hi-Lo structure, with a counter rotational groove to absorb cuttings from the borehole and reduce frictional resistance while inserting the screw

### OBJECTS AND SUMMARY

It is an object of the present invention to provide a concrete screw having reduced rotational resistance, decreased incidence of shearing, and increased resistance to pullout. According to the invention, the screw has a set of major and minor co-helical threads of a pitch generally at least equal to the shank diameter. Furthermore the screw embodies one or more counter-helical V-shaped grooves extending through the full height of the major and minor threads and into the shank of the screw. Preferably, the counter-rotational helical grooves are of a very coarse pitch, typically about two to six times the opposite pitch of the threads, preferably about five times. The screws also have secondary partial length grooves intermediate the V-shaped grooves.

### BRIEF DESCRIPTION OF THE DRAWINGS

Brief descriptions of the drawings of the invention will now be described by way of preferred and exemplary embodiments with reference to the accompanying diagrammatic drawings, which are not necessarily drawn to scale:

FIG. 1 is a side view of a concrete screw according to the present invention;

FIG. 2 is a cross-sectional view taken along the lines II-II of FIG. 1 showing a single convolute of major and minor threads and the counter-rotational grooves;

FIG. 3 is a sectional view taken along section line III-III of FIG. 1, and showing the geometry of the asymmetrical W-shaped cut-outs in the tip portion of the screw in a further embodiment of the invention.

FIG. 4 is a side view of another embodiment of the screw according to the present invention.

FIG. 5 is a side view of an enlarged view of the tip portion of the screw of FIG. 4.

FIG. 6 is a cross-sectional view taken along the lines VI-VI of FIG. 5 showing two sets of grooves.

### DETAILED DESCRIPTION OF THE PREFERRED AND EXAMPLARY EMBODIMENTS

In the following description, the same reference numbers are used for equivalent parts, although different embodiments of the invention may be shown and described:

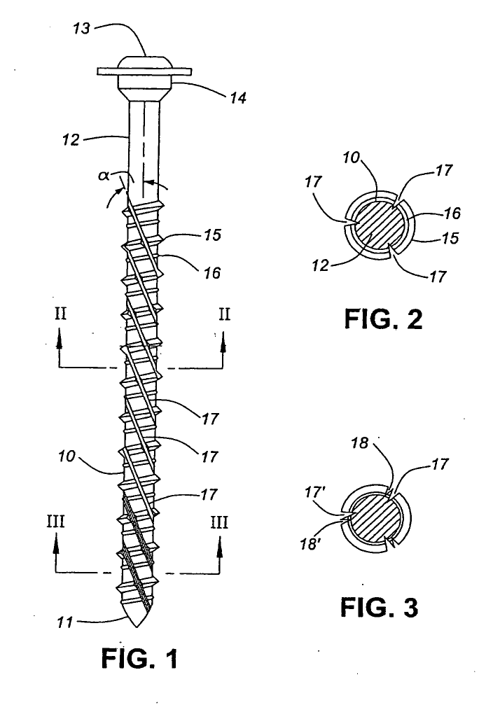

In FIG. 1 is illustrated an exemplary type of concrete screw incorporating the present invention. The screw is integrally formed, preferably of nickel, and comprises a shank portion 10, having at one end a tip 11. The opposite, second end of the shank portion 10, has a head end portion 12, which is unthreaded. Preferably the head end portion 12 has a somewhat increased diameter to provide a smooth transition to a head 13, for instance, by a frustoconical transitional section 14. The enlarged transitional section also enables reception of a larger or a more powerful screw driving means.

Between the tip 11 and head portion 12, the shank 10 has multiple convolutions of at least two helical threads. A first thread 15 has a crest diameter (the diameter of the virtual cylinder enclosing the outer periphery of the threads) greater than the shank diameter. Preferably, such crest diameter of major thread 15 exceeds the shank diameter from about 20 to 30 percent. Intermediate the major helical thread 15 is a minor helical thread 16. The crest diameter of minor helical thread 16 exceeds the diameter of the shank to a far lesser extent, in the order of 5 to 10 percent.

In contrast to conventional “Hi-Lo” screws, which have a relatively fine pitch, the pitch of the present screw is much greater. Preferably, the thread pitch in the present screw has a major crest-to-crest interval at least as large as the diameter of the shank 10 of the screw. Applicant believes that a thread pitch of less than the shank diameter, when threads as disclosed herein are used, results in excessive undercutting of the borehole walls, with resulting reduction in pull-out resistance.

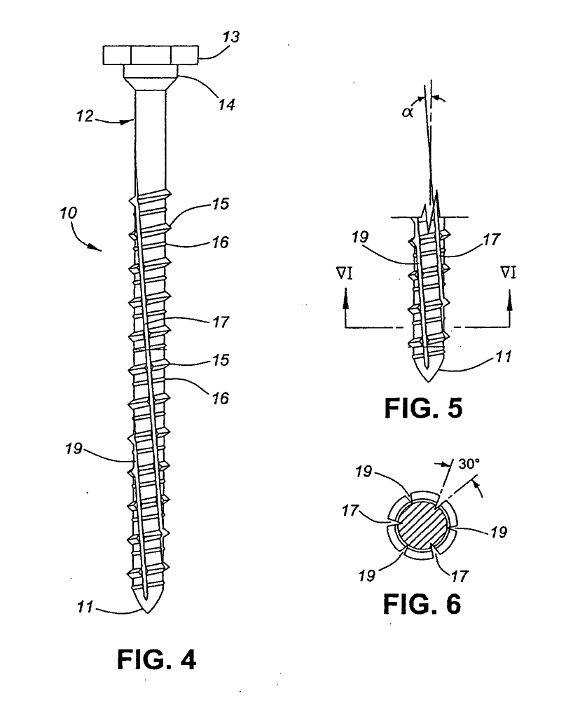

The screw of the present invention also includes a plurality of helical grooves, having a rotation of opposite hand to the rotation of the helical threads. In one embodiment, illustrated in FIGS. 1 and 2, a total of three counter-helical grooves 17 are illustrated. Grooves 17 are generally V-shaped, having a narrow apex angle of 30° or less. The grooves may be symmetrical (as illustrated in FIG. 2), or asymmetrical in the direction of the screw rotation. The grooves extend completely through the full height of both the major thread 15 and the minor thread 16, and penetrate into the shank 10. Preferably, the groove has a depth into the shank 10 which exceeds the height of the minor thread, whereby the screw diameter at the base of the groove is in the order of 5 to 10 percent less than the diameter of shank 10. The grooves 17 have a pitch of at least twice the opposite pitch of the threads. In the screw illustrated in FIG. 1, the pitch of the groove forms an angle α in the order of 30° with the axis of the screw. In comparison, the pitch may be significantly greater as illustrated in FIGS. 4 and 5. The steepest pitch exhibiting the benefits of the present invention forms an angle α of about 10° with the vertical axis of the screw.

In still a further aspect of the invention, illustrated in FIG. 3, a limited number of threads, such as the first two or three convolutions, depending on the pitch, and preferably at least 25 mm of threads, are cut not only by the counter-helical groove 17, but by an additional rotationally adjacent groove 18 which, in combination with groove 17, forms a W-shaped cut-out. An asymmetrical W cut-out of combined groove 17 and 18 is shown in FIG. 3, and provides a saw tooth aspect to the leading few convolutions of major and minor threads 15 and 16. This saw effect aids in the initial scarifying or cutting of a thread into the surface walls of the borehole into which the screw is driven.

Referring to FIG. 4, a further embodiment of the present screw is illustrated. The screw has a set of counter helical grooves of much steeper pitch, having an angle α of about 10° with the axis of the screw. In another embodiment of the invention, illustrated in FIGS. 5 and 6, a second set of grooves 19 is provided intermediate the previously described set of grooves. Those grooves, also of a V-shape, may extend over a limited portion from the tip end of the screw. For example, where there are three major grooves 17 extending the length of the screw, the three shorter intermediate grooves 19 may be provided for approximately ⅓ of the threaded length of the screw and are preferably at least 25 mm in length. Grooves 19 may also have an asymmetrical V-shape, inclined in the direction of rotation of the screw. Of course, the intermediate grooves 19 can be positioned adjacent the major grooves 17 to effect a W-shaped combination.

In operation, the screw is positioned in a borehole having a diameter slightly larger than the diameter of shank portion 10 and head end portion 12. By means of an appropriate interface, such as a Phillips, Robertson or Torques pattern driver hole or wrench flats, rotational forces are applied to head 13 of the screw to rotate the screw into the hole. The lead threads and cut-outs created by grooves 17 and 18 (19) carve an initial thread pattern, which is followed by major thread 15 and minor thread 16. Major thread 15 cuts significant thread tracks in the wall and provides the greatest resistance against pullout. Minor thread 16 penetrates the sidewall to a lesser extent, and provides a solid second bearing for the body of the screw, but without significant cutting or weakening of the wall.

It is believed that, with prior art fine pitch concrete screws, the concrete powder scored from the walls of the bore hole by the screw threads remains in the vicinity of the screw tip, and itself binds and compacts between the threads and the bore hole wall, significantly increasing resistance to the driving of the screw. In fact, in many designs of screw, this resistance in fine pitch screws is so high that the screw is incapable of transmitting the rotational forces from the head to the tip, and shearing of the screw body occurs in a disproportionately high number of instances.

In contrast, it is believed that the screw of the present invention does not retain the abraded concrete powder in the vicinity of the tip of the screw, but rather the series of helical groove allows the concrete powder to disperse along the length of the screw, and to the extent necessary, to fill in the grooves 17 (and 18, 19). This dispersion of concrete powder avoids the increased resistance at the tip of the screw, thereby permitting full transmission of torque throughout the screw length, and full penetration to the design depth, with vastly improved shear resistance and pullout resistance. Furthermore, in view of the coarse pitch of the major and minor threads, there is a significant decrease in the tendency, as exhibited by prior art screws, to “drill out” or break away the concrete structure between the thread tracks.

In one embodiment of a concrete screw exhibiting the foregoing features, the screw has a length of 92 mm, a threaded length of 60 mm, a shank diameter of 5.7 mm, a major thread crest diameter of 7.5 mm, and a minor thread crest diameter of 5.85 mm, and a thread pitch of 5.7 mm. The screw also had three counter-helical grooves, having a groove depth of 5.25 mm and a groove pitch of 30 mm (about 30°). Asymmetrical ‘W’ shaped cut-outs are provided on the first three convolutions (initial 25 mm) of the major and minor threads. In another embodiment, the screw has the same length, shank and thread diameters and thread pitch. However, the pitch of the counter helical groove is about 120 mm. In comparison with traditional concrete screws of the same shank diameter, but thread pitch of one-half the shank diameter, and without the helical grooves of the present invention, the screw driving torque required for the screw of the present invention was only 60 percent of that of prior art screws while pullout resistance was 70 percent higher than with the traditional screws.

The screw as described above exhibits greater pull-out resistance, decreased torque requirements and consequently greatly reduced failure from shearing of the screw during installation. This significantly speeds installation, as it avoids redrilling of pilot boreholes for installation of a replacement screw, and possibly total replacement of the anchor system involved.

While the embodiments described above have a variation in the number of convolutions with W-cut grooves, the symmetrical or asymmetrical shape of the grooves and in the degree of pitch of the grooves and length of the intermediate grooves, those skilled in the art will readily appreciate that it is within the scope of the present invention to modify the numbers of W-cut convolutions, the geometry of the cuts and the degree of pitch or length, without departing from the scope of the invention as recited in the accompanying claims. Substitution of elements from one described embodiment to another are also fully intended and contemplated. It is the intention, therefore, to be limited only as indicated by the scope of the claims appended hereto, and equivalents thereof.

1. A screw fastener for use in a masonry element having a pilot hole of predetermined length and diameter, the screw comprising:
a shank having a diameter less than the diameter of the pilot hole, and having a tip at one end and a head at the other end;
a set of helical threads extending from the tip over a portion of the length of the shank, wherein said threads have a pitch at least as great as the diameter of the shank; and
a set of one or more helical grooves of the opposite rotational hand to the threads, which grooves extend through the threads and into the shank, wherein the pitch of the grooves is in the range of two to twenty times the diameter of the shank.

2. The screw of claim 1, wherein the set of threads comprises one major thread and one minor thread.

3. The screw of claim 2, wherein the major thread extends outwardly of the shank about ⅕ of the shank diameter.

4. The screw of claim 2, wherein the minor thread extends outwardly of the shank by about 1/20 of the shank diameter.

5. The screw of claim 2, wherein the major and minor threads are equally spaced from each other.

6. The screw of claim 1, wherein the grooves extend into the shank a depth of up to ¼ the height of the major threads.

7. The screw of claim 1, wherein in a limited number of initial thread convolutions, the grooves comprise radially inwardly narrowing W-shaped cut-outs.

8. The screw of claim 7, wherein the W-shaped cut-outs are asymmetrically inclined in the driving direction of the screw.

9. The screw of claim 1, wherein a second set of intermediate grooves extends over a limited initial portion of the shank, intermediate said set of helical grooves.

10. The screw of claim 9 wherein the limited portion is at least 25 mm.

11. The screw of claim 9 wherein the limited portion is at least ⅓ of the length of the threaded portion of the screw.

12. The screw of claim 1, wherein the number of helical grooves is three.

13. The screw of claim 12, wherein there are three secondary helical grooves extending intermediate said helical grooves for a limited portion of the shank adjacent to the tip.

14. The screw of claim 12 wherein the limited portion is at least 25 mm.

15. The screw of claim 12 wherein the limited portion is at least ⅓ of the length of the threaded portion of the screw.

16. The screw of claim 1, wherein the pitch of the grooves is in the range of two to six times the diameter of the shank.

17. The screw of claim 1, wherein the pitch of the grooves forms an angle of less than 30 degrees with a longitudinal axis of the screw.

18. The screw of claim 1, wherein the pitch of the grooves forms an angle of more than 10 degrees with a longitudinal axis of the screw.

19. The screw of claim 1, wherein at least one of the helical grooves extend over substantially the entire portion of the length of the shank.

20. The screw of claim 1, wherein the helical grooves extend through two or more turns of the helical thread.
